(19) United States
(12) Patent Application Publication
(10) Pub. No.: US 2008/0071713 A1
(43) Pub. Date: Mar. 20, 2008

(54) POWER SAVING METHOD AND SYSTEM FOR A MOBILE DEVICE

(75) Inventor: Yu Teng Tung, Taipei County (TW)

Correspondence Address: QUINTERO LAW OFFICE, PC, 2210 MAIN STREET, SUITE 200, SANTA MONICA, CA, 90405, US

(73) Assignees: QISDA CORPORATION, TAOYUAN (TW); BENQ CORPORATION, TAIPEI (TW)

(21) Appl. No.: 11/855,942

(22) Filed: Sep. 14, 2007

(30) Foreign Application Priority Data
Sep. 14, 2006 (TW) TW95134007

(51) Int. Cl. G06F 15/18

(52) U.S. Cl. 706/21; 706/16

(57) ABSTRACT

A power saving method for a mobile device is disclosed. Multiple user samples are generated. One behavior vector for each of the user samples is calculated. A neural network system is trained using the user samples and the corresponding behavior vectors. Multiple user events are collected. The user events are transformed to multiple behavior samples using a weighting transformation function. The behavior samples are classified into behavior sample groups. The behavior sample group comprising the most behavior samples is obtained. The behavior vector for the behavior sample group comprising the most behavior samples is calculated. The neural network system is trained using the behavior sample group comprising the most behavior samples and the corresponding behavior vector.

### BACKGROUND OF THE INVENTION

1. Field of the Invention

The invention relates to a mobile device, and more particularly to a power saving method and system for a mobile device.

2. Description of the Related Art

A cell phone system provides a network composed of multiple base stations communicating with radio stations or mobile phones. Each base station may cover a specific geography area or specified cells. The cell phone system enables each mobile phone to communicate with a nearest base station to reduce frequency emission to each mobile phone.

When powered on, a mobile phone searches an optimum base station at the currently located area to be authorized and registered. The mobile phone registers and enters a standby mode, and connects to the registered base station to transmit and receive communication data. When entering a standby mode, a mobile phone activates a hibernation mode to lower power consumption, thereby enabling long-term standby. The operational mode of a mobile phone, however, switched between the high power mode (in a communication mode or non-standby mode) and the low power mode (in a standby mode) may cause significant power consumption, and, thus, it can be seen that communication modes are highly interrelated with power consumption levels.

Thus, a power saving method and system for a mobile device, utilizing a neural network based on current user behaviors, to predict future user behaviors, is desirable.

### BRIEF SUMMARY OF THE INVENTION

Power saving methods for a mobile device are provided. An exemplary embodiment of a power saving method for a mobile device comprises the following. Multiple user samples are generated. One behavior vector for each of the user samples is calculated. A neural network system is trained using the user samples and the corresponding behavior vectors. Multiple user events are collected. The user events are transformed to multiple behavior samples using a weighting transformation function. The behavior samples are classified into behavior sample groups. The behavior sample group comprising the most behavior samples is obtained. The behavior vector for the behavior sample group comprising the most behavior samples is calculated. The neural network system is trained using the behavior sample group comprising the most behavior samples and the corresponding behavior vector.

Power saving systems for a mobile device are provided. An exemplary embodiment of a power saving system for a mobile device comprises a sample generation module, an estimation module, an event collection module, a weighting transformation module, and a training module. The sample generation module randomly generates multiple user samples. The estimation module calculates one behavior vector for each of the user samples. The training module trains a neural network system using the user samples and the corresponding behavior vectors. The event collection module collects multiple user events. The weighting transformation module transforms the user events to multiple behavior samples using a weighting transformation function, classifies the behavior samples into behavior sample groups, and obtains the behavior sample group comprising the most behavior samples. The estimation module calculates the behavior vector for the behavior sample group comprising the most behavior samples. The training module trains the neural network system using the behavior sample group comprising the most behavior samples and the corresponding behavior vector.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of an embodiment of generating weighting event vectors;

FIG. 2 is a flowchart of an embodiment of a power saving method for a mobile device; and

FIG. 3 is a schematic view of an embodiment of a power saving system for a mobile device.

### DETAILED DESCRIPTION OF THE INVENTION

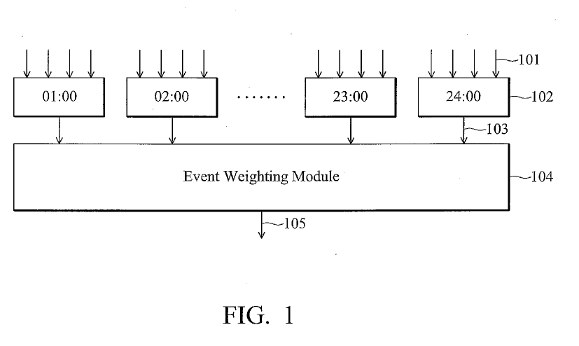

Several exemplary embodiments of the invention are described with reference to FIGS. 1 through 3, which generally relate to power saving method for a mobile device. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention discloses a power saving method and system for a mobile device, utilizing a neural network based on current user behaviors to predict future user behaviors.

A neural network is a powerful data-modeling tool capable of capturing and representing complex input/output relationships. Development of neural network technology was spurred by the desire to develop an artificial system that could perform “intelligent” tasks similar to those performed by the human brain. In this embodiment, a neural network is applied to predict future user behaviors for implementing reduced power consumption in a mobile phone.

An embodiment of a power saving method first randomly generates user samples and trains a neural network system using an estimation function to shorten the learning time required to practically train oncoming user samples. Next, user samples are collected and classified to locate a sample type comprising the most user sample. The sample type represents the main behavior mode of a mobile phone user and user samples of the sample type are applied to train and create a personalized neural network system. Next, oncoming user behaviors are predicted according to latest user samples using the neural network system, thereby dynamically adjusting power saving parameters.

If a user life is regular, the use of a mobile phone for the user may also be regular. Thus, an embodiment of the method quantifies the frequency of use of the mobile phone at each time segment and optimizes power consumption when the mobile phone is used less.

FIG. 1 is a schematic view of an embodiment of generating weighting event vectors.

User behaviors for a mobile phone serve as a plurality of user samples relating to the time (101) and each event occurs at a selected time segment (such as 01:00, 2:00, . . . , 23:00, and 24:00) (102). A user making a phone call at 03:00, for example, is an event. The mobile phone idle at 17:00 is as an event. The mobile phone of the user having an incoming call also is an event. Events for each time segment are statistically calculated to generate an integrated event vector (103). The integrated event vector is processed according to weighting factors using a weighting transformation function (104) to output a weighting event vector (105). Each element of the weighting event vector serves as a user sample, representing a user behavior at a time interval.

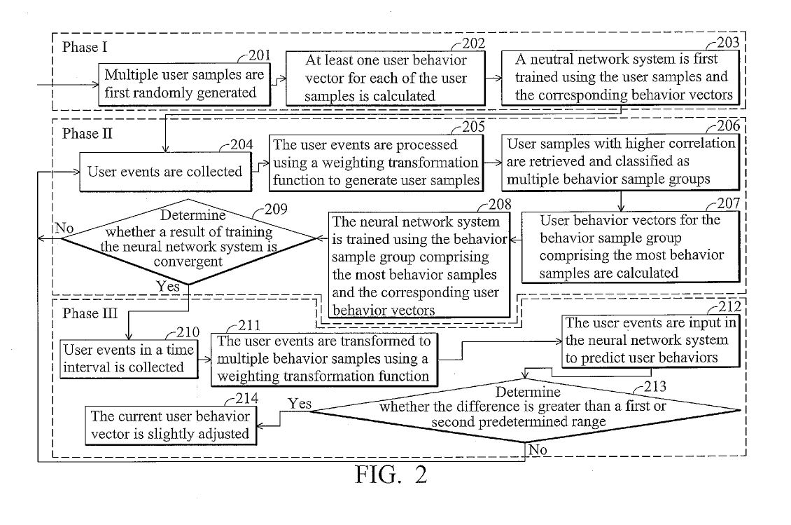

FIG. 2 is a flowchart of an embodiment of a power saving method for a mobile device.

In phase 1, multiple user samples are first randomly generated (201), and at least one behavior vector for each of the user samples are calculated using an estimation equation (202). Each element of the user behavior vectors represents the use frequency (indicating the weight) of the mobile phone at a time segment or a use mode of the user. A user behavior vector is calculated using the estimation equation and the design of the estimation equation is unable to match the real conditions, such that the calculation result must comprise differences. Thus, a neutral network system is first trained using the user samples and the corresponding behavior vectors to calculate accurate a user behavior vector (203). When the training is complete, the neural network system is provided with basic prediction ability.

Next, in phase 2, a personalized neural network system is trained and generated according to historical user behaviors. User events are first collected. Events generated while communicating using the mobile phone are recorded at every time interval (204). The user events are processed using a weighting transformation function to generate user samples (205), thereby collecting a definite number of user samples. Next, user samples with higher correlation are retrieved and classified as multiple behavior sample groups and a behavior sample group comprising the most behavior samples is determined according to similarity of the retrieve behavior samples (206). The behavior sample group comprising the most behavior samples characterizes representative user behaviors.

Next, the behavior sample group comprising the most behavior samples is retrieved and the user behavior vectors for the behavior sample group comprising the most behavior samples are calculated using an estimation function (207), and the neural network system is trained using the behavior sample group comprising the most behavior samples and the corresponding user behavior vector (208). It is determined whether the training result corresponds to an expected value, indicating determining whether a result of training the neural network system is convergent (209). If the result of training the neural network system is convergent, a median of the behavior samples of the behavior sample group is input in the neural network system and an output of training the neural network system is determined as a current user behavior vector. The current user behavior vector comprises multiple elements. The elements represents weighting factors in different time segments. The current user behavior vector is the identification of user behavior standards and is compared with future prediction results. If the neural network system is divergent, more behavior samples are collected to train the neural network system by repeating steps 204˜208.

When the described process is complete, the neural network system is provided with a basic ability to predict user behaviors. User behaviors may gradually or suddenly change with the time and, to adapt to the variation, a learning principle is thus defined.

In phase 3, user events in a time interval are collected (210), the user events are transformed to the multiple behavior samples using a weighting transformation function (211), and the user events are input in the neural network system to predict user behaviors (212). It is determined whether the difference, detected by the neural network system, between results for predicting user behaviors and a current user behavior vector determined by an output of training the neural network system is greater than a first or second predetermined range (213). If the difference is greater than the first predetermined range, the current user behavior vector is slightly adjusted (214), and the process proceeds to step 210. If the difference is greater than the second predetermined range, the process proceeds to and repeats steps 204˜209, to re-collect behavior samples to train the neural network system.

When completely trained by the three phases, the neural network system acquires events that have occurred in the latest time interval to predict use weightings of a mobile phone at each time segment within the next time interval, and adjusts power consumption parameters according to the weightings. The parameters comprise waiting time to switch to a standby mode, a time interval for a wake up mode of a mobile phone, or the like.

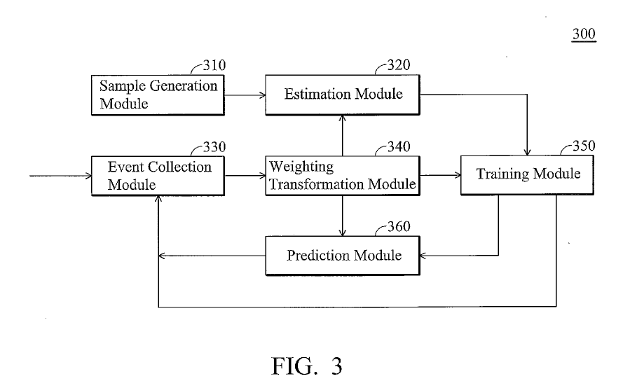

FIG. 3 is a schematic view of an embodiment of a power saving system for a mobile device.

The power saving system 300 comprises a sample generation module 310, an estimation module 320, an event collection module 330, a weighting transformation module 340, a training module 350, and a prediction module 360.

In phase 1, sample generation module 310 randomly generates multiple user samples. Estimation module 320 calculates at least one behavior vector for each of the user samples. Training module 350 trains a neural network system according to the user samples and the corresponding behavior vectors retrieved from sample generation module 310 and estimation module 320.

In phase 2, event collection module 330 collects user events every a time interval. Weighting transformation module 340 generates behavior samples, classifies the behavior samples to behavior sample groups according to similarity, and locates a behavior sample group comprising the most behavior samples. Next, estimation module 320 calculates user behavior vectors corresponding to each user sample. Training module 350 trains the neural network system using the behavior sample group comprising the most behavior samples and the corresponding behavior vectors retrieved from estimation module 320 and weighting transformation module 340, determines whether a result of training the neural network system is convergent, and if so, inputs a median of the behavior samples of the behavior sample group in the neural network system and determines an output of training the neural network system as a current user behavior vector, and, if not, collects more behavior samples to train the neural network system.

In phase 3, event collection module 330 collects user events within a time interval. Weighting transformation module 340 generates behavior samples according to the user events. Prediction module 360 retrieves behavior samples from weighting transformation module 340, predicts user behaviors using the neural network system, and determines whether the difference, detected by the neural network system, between results for predicting user behaviors and a current user behavior vector determined by an output of training the neural network system is greater than a first or second predetermined range. If the difference is greater than the first predetermined range, the current user behavior vector is slightly adjusted. If the difference is greater than the second predetermined range, behavior samples are re-collected to train the neural network system.

An example of event transformation is described in the following.

User behaviors for a day are divided to for transitions that comprise 00:00˜06:00, 06:00˜12:00, 12:00˜18:00, and 18:00˜24:00 (00:00). Predictable events comprise at least “incoming calls”, “outgoing calls”, and “no use”. User events and time intervals are represented by a binary string that, for example, “1000” represents the time interval 00:00˜06:00, “0100” represents the time interval 06:00˜12:00, “0010” represents the time interval 12:00˜18:00, “0001” represents the time interval 18:00˜24:00 (00:00), “100” represents “incoming calls”, “010” represents “outgoing calls”, and “001” represents “no use”. An incoming, for example, received at 06:00˜12:00 represents “0100 010” and a mobile phone being no use at 18:00˜24:00 represents “0001 001”, in which the prior four binary codes represent time intervals and the last three codes represent events. Events for each time intervals are statistically calculated to generate an integrated event vector. “0001 250”, for example, indicates two incoming calls and five outgoing calls are generated at 18:00˜24:00.

Since the number of detected events is insignificant, an embodiment of the method employees an event transformation function to transform integrated event vectors to calculate the use frequency of a mobile phone at each time interval. Thus, the importance of an event and the number of the importance should be estimated.

Ten or a hundred of incoming calls received in a time interval is considered high use frequency so the difference between the two numbers is insignificant, such that the weighting of importance of the event should be adjusted.

Integrated event vectors, for example, for each time interval are represented as:

“1000 001” at 00:00˜06:00, 0100 110: at 06:00˜12:00, “0010 210” at 12:00˜18:00, and “0001 130” at 18:00˜2400.

An event transformation function is represented as:

f (x, y, z)=(X*0.3+Y*0.2+(−1)*Z)/5 (suppose the event number<5), where X indicates the incoming call event, Y indicates the outgoing call event, and Z indicates the no use event. The described integrated event vectors are calculated as f (0, 0, 1)=(−0.2), f (1, 1, 0)=0.1, f (2, 1, 0)=0.16, and f (1, 3, 0)=0.18. Thus, (−0.2, 0.1, 0.16, 0.18) indicates the output weighting event vector shown in FIG. 1, i.e. the input sample to neural network system.

A neural network system operates using artificial neurons, thus, the connection intensity between neurons can be regarded as parameters. The procedure training the neural network system repeatedly calculates and changes the parameters, comprising providing samples, target vectors, and a set of initial weighting factors, inputting the samples, calculating the samples according to the vectors and weighting factors, outputting calculation results, and adjusting the weighting factors according to the results and the target vectors.

As described, the learning process of the neural network system is implemented by the adjustment. If the difference between the output results and the target vectors is considerable the degree of accuracy provided is lower and the weighting factors must be adjusted. The described steps are repeated until the difference between the output results and the target vectors is acceptable. Thus, the neural network system is convergent.

A process of the neural network technique applied to the invention is described as follows.

In phase 1, a great number of samples are generated using a random method, a genetic algorithm, or a designed equation. Next, each sample is estimated using an estimation function, and estimated samples are input to a neural network system to be trained according to calculation results.

In phase 2, five samples, for example, are provided and represented as S1= [symbol] 0.5, 0.5, 0.5, 0 [symbol] , S2= [symbol] 0.49, 0.49, 0.49, 0 [symbol] , S3= [symbol] 0.51, 0.51, 0.51, 0 [symbol] , S4= [symbol] 0.52, 0.48, 0.52, 0 [symbol] , and S5= [symbol] 0.48, 0.52, 0.48, 0 [symbol] , where each number in each sample represents a weighting of an event. Sample S1 comprises four events and weightings of each event comprise 0.5, 0.5, 0.5, and 0. Estimation values g(S1), g(S2), g(S3), g(S4) are calculated using an estimation function g(x). Samples S1˜S5 are input to the neural network system to train according to the estimation values, represented as:

{Ain(sample input)→ [symbol] estimation function [symbol] →Aeval(estimation value)} and {Ain(sample input)→ [symbol] neural network system [symbol] →Aout(training result)}.

Aevel is compared with Aout and parameters of the neural network system are adjusted according to requirements.

When the neural network system is convergent, a median of [symbol] 0.5, 0.5, 0.5, 0 [symbol] is located to input the neural network system to generate training results. Since the neural system is convergent, the located median should be representative, and the currently generated training results are representatively determined as user behaviors, thereby generating a “current user behavior vector (Fin)” according to the training results.

In phase 3, a behavior sample is collected and directly input to the neural network system that training information is updated at time intervals, and predict results are compared with the last “current user behavior vector (Fin)” to obtain a comparison value “v”.

Additionally, an expected value “a” and a threshold value “b” are defined. Expected value “a” defines similarity between two behavior vectors. A similarity value greater than “a” indicates two behavior vectors are similar. Threshold value “b” also defines similarity between two behavior vectors. A similarity value less than “b” indicates two behavior vectors are diverse. In this embodiment, expected value “a” and threshold value “b” are defined as, but is not limited to, 0.2 and 0.1 respectively.

If a<v<1, similarity between two behavior vectors are expectable, and the neural network system detects and slightly adjusts the two behavior vectors.

If b<v<a, a learning process of the neural network system is activated to adjust weighting factors in the neural network system.

If 0<v<b, the neural network system is reset and samples are re-collected to re-train the neural network system.

With respect to the weighting of an event, for example, when “current user behavior vector (Fin)”= [symbol] 0.6, 0.8, 0.5, 0 [symbol] , prediction result(B)= [symbol] 0.6, 0.5, 0.55, 0 [symbol] , v=0.8−0.5=0.3>0.2, such that a<v<1. Thus, the overall difference for the neural network system is under an expected range but the difference between individual weightings is considerable, such that slight adjustment is required. An embodiment of the invention utilizes, but is not limited to, a trimming equation to adjust weighting factors, the trimming equation represented as:

f(x)=Wold+(Wnew−Wold)*(Single-element−diff/Total diff)(1/element num)

The described behavior vectors and prediction results are substituted in the equation that 0.8−(0.8−0.5)*(0.3/0.25)*(1/4)=0.8−0.09=0.71.

Thus, a new “current user behavior vector (Fin)”= [symbol] 0.6, 0.71, 0.5, 0

[symbol]

Methods and systems of the present disclosure, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power saving method for a mobile device, comprising:
generating multiple user samples;
calculating one behavior vector for each of the user samples;
training a neural network system using the user samples and the corresponding behavior vectors;
collecting multiple user events;
transforming the user events to multiple behavior samples using a weighting transformation function;
classifying the behavior samples into behavior sample groups;
obtaining the behavior sample group comprising the most behavior samples;
calculating the behavior vector for the behavior sample group comprising the most behavior samples; and
training the neural network system using the behavior sample group comprising the most behavior samples and the corresponding behavior vector.

2. The power saving method as claimed in claim 1, further comprising:
determining whether a result of training the neural network system is convergent;
if the result of training the neural network system is convergent, inputting a median of the behavior samples of the behavior sample group in the neural network system and determining an output of training the neural network system as a current user behavior vector; and
if the result of training the neural network system is not convergent, collecting more behavior samples to train the neural network system.

3. The power saving method as claimed in claim 2, wherein the current user behavior vector comprises multiple elements, the elements represent weighting factors in different time segments.

4. The power saving method as claimed in claim 1, further comprising:
collecting the user events in a time interval;
transforming the user events to the multiple behavior samples using the weighting transformation function; and
inputting the user events to the neural network system for predicting user behaviors.

5. The power saving method as claimed in claim 4, further comprising:
if the neural network system detects the difference between results for predicting user behaviors and a current user behavior vector determined by an output of training the neural network system being greater than a first predetermined range, slightly adjusting the current user behavior vector; and
if the neural network system detects the difference between the results for predicting user behaviors and the current user behavior vector being greater than a second predetermined range, re-collecting behavior samples to train the neural network system.

6. The power saving method as claimed in claim 1, wherein each behavior vector comprises a plurality of weighting factors that correspond to user behaviors.

7. A power saving system for a mobile device, comprising:
a prediction module;
a sample generation module, randomly generating multiple user samples;
an estimation module, coupled to the sample generation module, calculating one behavior vector for each of the user samples;
a training module, coupled to the estimation module, training a neural network system using the user samples and the corresponding behavior vectors;
an event collection module, collecting multiple user events; and
a weighting transformation module, coupled to the event collection module and the training module, transforming the user events to multiple behavior samples using a weighting transformation function, classifying the behavior samples into behavior sample groups, and obtaining the behavior sample group comprising the most behavior samples;
wherein the estimation module calculates the behavior vector for the behavior sample group comprising the most behavior samples, and the training module trains the neural network system using the behavior sample group comprising the most behavior samples and the corresponding behavior vector.

8. The power saving system as claimed in claim 7, wherein the training module determines whether a result of training the neural network system is convergent, if the result of training the neural network system is convergent, inputs a median of the behavior samples of the behavior sample group in the neural network system and determines an output of the neural network system as a current user behavior vector; and, if the result of training the neural network system is not convergent, collects more behavior samples to train the neural network system.

9. The power saving system as claimed in claim 8, wherein the current user behavior vector comprises multiple elements, the elements representing weighting factors in different time segments.

10. The power saving system as claimed in claim 7, wherein the sample generation module collects the user events in a time interval, the weighting transformation module transforms the user events to the multiple behavior samples using the weighting transformation function, the training module retrieves the behavior samples to train the neural network system, and the prediction module predicts user behaviors according to the training result.

11. The power saving system as claimed in claim 10, wherein the prediction module slightly adjusts the current user behavior vector if the neural network system detects the difference between results for predicting user behaviors and a current user behavior vector determined by an output of training the neural network system being greater than a first predetermined range and re-collects behavior samples to train the neural network system if the neural network system detects the difference between the results for predicting user behaviors and the current user behavior vector being greater than a second predetermined range.

12. The power saving system as claimed in claim 7, wherein each behavior vector comprises a plurality of weighting factors that correspond to user behaviors.

13. A computer-readable storage medium storing a computer program providing a power saving method for a mobile device, comprising using a computer to perform the steps of:
generating multiple user samples;
calculating one behavior vector for each of the user samples; training a neural network system using the user samples and the corresponding behavior vectors;
collecting multiple user events;
transforming the user events to multiple behavior samples using a weighting transformation function;
classifying the behavior samples into behavior sample groups;
obtaining the behavior sample group comprising the most behavior samples;
calculating the behavior vector for the behavior sample group comprising the most behavior samples; and
training the neural network system using the behavior sample group comprising the most behavior samples and the corresponding behavior vector.

14. The computer-readable storage medium as claimed in claim 13, further comprising:
determining whether a result of training the neural network system is convergent;
if the result of training the neural network system is convergent, inputting a median of the behavior samples of the behavior sample group in the neural network system and determining an output of training the neural network system as a current user behavior vector; and
if the result of training the neural network system is not convergent, collecting more behavior samples to train the neural network system.

15. The computer-readable storage medium as claimed in claim 14, wherein the current user behavior vector comprises multiple elements, the elements representing weighting factors in different time segments.

16. The computer-readable storage medium as claimed in claim 13, further comprising:
collecting the user events in a time interval;
transforming the user events to the multiple behavior samples using the weighting transformation function; and
inputting the user events to the neural network system to predict user behaviors.

17. The computer-readable storage medium as claimed in claim 16, further comprising:
if the neural network system detects the difference between results for predicting user behaviors and a current user behavior vector determined by an output of training the neural network system being greater than a first predetermined range, slightly adjusting the current user behavior vector; and
if the neural network system detects the difference between the results for predicting user behaviors and the current user behavior vector being greater than a second predetermined range, re-collecting behavior samples to train the neural network system.

18. The computer-readable storage medium as claimed in claim 13, wherein each behavior vector comprises a plurality of weighting factors that correspond to user behaviors.
